(19) United States
(12) Patent Application Publication
(10) Pub. No.: US 2013/0249227 A1
(43) Pub. Date: Sep. 26, 2013

(54) Portable Stand for a Portable Electronic Device

(71) Applicant: Paul Lin, Tainan City (TW)

(72) Inventor: Paul Lin, Tainan City (TW)

(21) Appl. No.: 13/693,555

(22) Filed: Dec. 4, 2012

(30) Foreign Application Priority Data
Mar. 26, 2012 (TW) 101205416

(51) Int. Cl. F16M 13/06

(52) U.S. Cl. CPC F16M 13/06
USPC 294/142

(57) ABSTRACT

A portable stand includes a handle rod, a clamp, and a connecting mechanism. The clamp can detachably clamp a portable electronic device. The connecting mechanism interconnects the handle rod and the clamp such that the handle rod is foldable and rotatable to various angles relative to the clamp. A socket member of the connecting mechanism has a socket wall that has an open end edge and at least one slit, and that defines a receiving space. An engaging member of the connecting mechanism has a ball part that is rotatably mounted in the receiving space and a stem that is connected to the ball part and that is extendable into the slit when the handle rod is folded over the clamp.

### CROSS-REFERENCE TO RELATED APPLICATION

This application claims priority of Taiwanese Application No. 101205416, filed on Mar. 26, 2012,

### BACKGROUND OF THE INVENTION

1. Field of the Invention

The invention relates to a portable stand for a portable electric device, and more particularly to a portable stand having a clamp and a handle rod foldable over the clamp.

2. Description of the Related Art

Generally, tablet computers and personal digital assistants (PDA) are designed for portable use. However, the tablet computers and the personal digital assistants have a size not suitable for holding over a long period of time and cannot stand on a table on their own.

For overcoming the aforesaid disadvantage, Taiwanese Utility Model No. M419011 discloses a portable stand adapted for clamping a portable electronic device so as to be held by a user or to inclinedly stand on a table. However, when the portable electronic device clamped by the portable stand is turned off for storage together with the portable stand, the portable electronic device cannot intimately abut against the portable stand and thus, the portable electronic device and the portable stand as a whole take up too much space.

### SUMMARY OF THE INVENTION

Therefore, an object of this invention is to provide a portable stand that is suited for use with a portable electronic device, and that can alleviate the aforesaid drawback of the prior art.

According to the present invention, a portable stand for a portable electronic device includes a handle rod, a clamp, and a connecting mechanism.

The clamp includes a clamp wall that has two opposite clamping portions for detachably clamping the portable electronic device and that has abase portion interconnecting the clamping portions.

The connecting mechanism interconnects pivotally the handle rod and the clamp such that the handle rod is foldable and rotatable to various angles relative to the clamp. The connecting mechanism includes a socket member that is disposed on one of the handle rod and the clamp, and an engaging member that is disposed on the other one of the handle rod and the clamp. The socket member has a socket wall that has an open end edge and at least one slit extending from the open end edge in a direction away from the open end edge, and that defines a receiving space, which opens at the open end edge. The engaging member has a ball part that is rotatably mounted in the receiving space and a stem that is connected to the ball part and that is extendable into the slit when the handle rod is folded over the clamp.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing the preferred embodiment of a portable stand according to the present invention assembled with a portable electronic device;

FIG. 2 is a fragmentary, partly sectional front view showing the preferred embodiment;

FIG. 3 is a fragmentary side view showing the preferred embodiment; and

FIG. 4 is a partly sectional front view showing the preferred embodiment in a state for storage.

### DETAILED DESCRIPTION OF THE PREFERRED EMBODIMENT

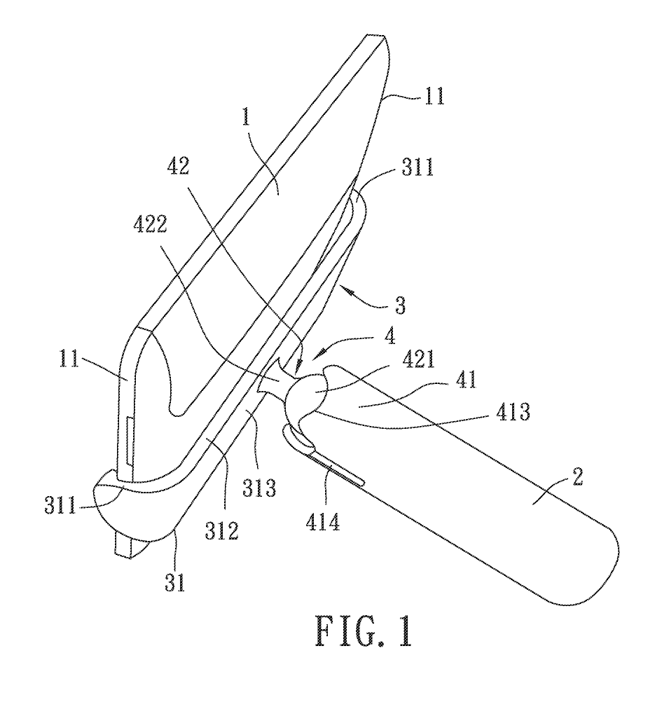

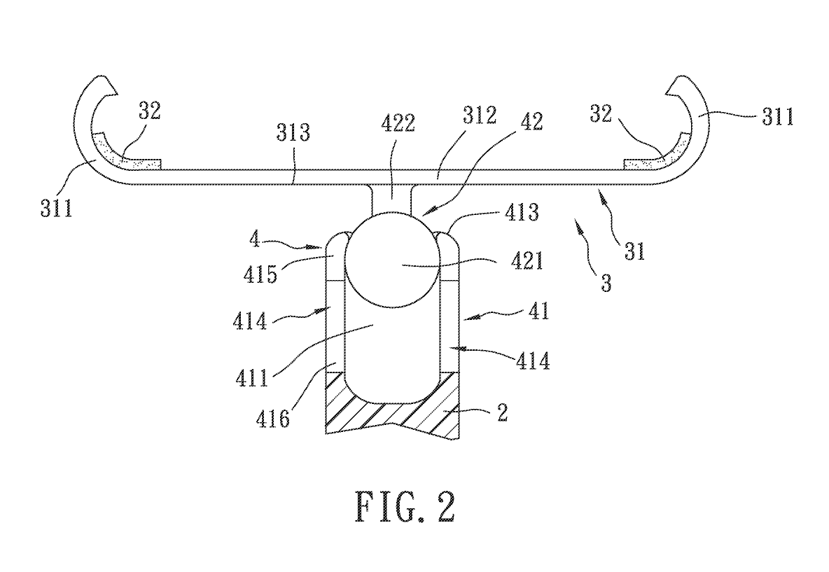

Referring to FIGS. 1 to 3, the preferred embodiment of a portable stand according to the present invention is adapted for clamping a portable electronic device 1 that has two opposite lateral sides 11. The portable stand includes a handle rod 2 for holding by a user, a clamp 3 for detachably clamping the portable electronic device 1, and a connecting mechanism 4 that pivotally interconnects the handle rod 2 and the clamp 3 such that the handle rod 2 is foldable and rotatable to various angles relative to the clamp 3.

In this embodiment, the handle rod 2 is exemplified as a cylindrical rod but the present invention is not limited thereto.

The clamp 3 includes a clamp wall 31 that has two opposite clamping portions 311 for detachably clamping the portable electronic device 1 and that has a base portion 312 interconnecting the clamping portions 311. In this embodiment, the base portion 312 is plate-shaped, and the clamping portions 311 are respectively configured as hooks. The base portion 312 of the clamp 3 has a back side 313 facing the handle rod 2.

Preferably, the clamp 3 further includes two cushion pads 32 respectively disposed on the clamping portions 311.

In this embodiment, the connecting mechanism 4 includes a socket member 41 that is disposed on the handle rod 2, and an engaging piece 42 that is disposed on the clamp 3. Alternatively, the socket member 41 may be disposed on the clamp 3, and the engaging piece 42 may be disposed on the handle rod 2. The socket member 41 has a socket wall 412 that has an open end edge 413 and two opposite spaced-apart slits 414 that extend from the open end edge 413 in a direction away from the open end edge 413. The socket wall 32 defines a receiving space 411, which opens at the open end edge 413. In this embodiment, the socket member 41 is integrally formed in one end of the handle rod 2. The open end edge 413 is proximate to the back side 313 of the clamp 3. The two slits 414 extend from the open end edge 413 along a longitudinal direction of the handle rod 2. Each slit 414 has a wide segment 415 that is proximate to the open end edge 413, and a narrow segment 416 that is distal from the open end edge 413. In actual implementation, the design of each slit 414 makes it possible for the socket wall 412 to be resilient for facilitating engagement with the engaging member 42. Although the number of the slits 414 in this embodiment is two, the present invention is not limited in this respect.

The engaging member 42 has a ball part 421 that is rotatably mounted in the receiving space 411 of the socket member 41 and a stem 422 that is connected to the ball part 421 and that is extendable into one of the slits 414 of the socket member 41 when the handle rod 2 is folded over the clamp 3. In this embodiment, the stem 422 of the engaging member 42 integrally projects from the back side 313 of the clamp 3, and interconnects the ball part 421 and the back side 313. The stem 422 of the engaging member 42 has a stem diameter that is greater than a width of the narrow segment 416, and that is smaller than or equal to a width of the wide segment 415.

In use, the two opposite lateral sides 11 of the portable electronic device 1 are respectively clamped by the clamping portions 311 and respectively abut against the corresponding cushion pads 32 of the clamping portions 311 so as to prevent the portable electronic device 1 from slipping off. A user is able to hold the handle rod 2 and to adjust the same to various angles relative to the clamp 3. The viewing angle of the portable electronic device 1 may also be adjusted based on the relative angle between the handle rod 2 and the clamp 3 to facilitating viewing. Besides, by virtue of the connections among the handle rod 2, the connecting mechanism 4, and the clamp 3, the handle rod 2 is able to support the portable electronic device 1 to stand on a table.

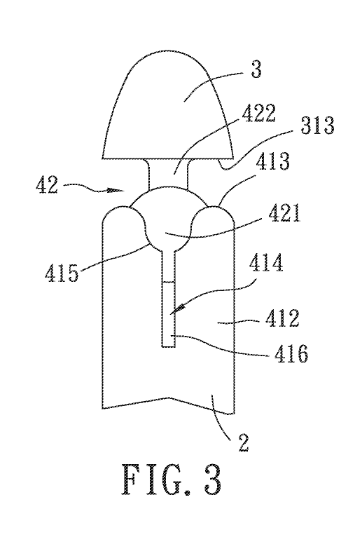

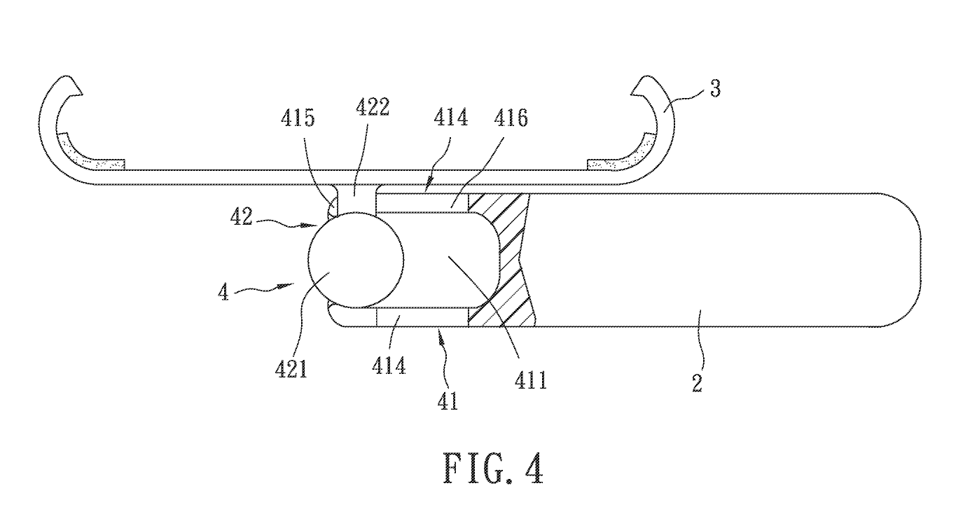

Further referring to FIGS. 1 to 4, when the portable stand is converted from an extended state as shown in FIG. 3 to a storage state as shown in FIG. 4, the clamp 3 is first rotated relative to the handle rod 2 such that the back side 313 and the slits 414 of the socket member 41 are parallel with each other in their longitudinal directions. When the stem 422 of the engaging member 42 is moved to be close to and then extends into the wide segment 416 of one of the slits 44, the handle rod 2 is folded over the base portion 312 of the clamp 3 in a parallel manner. Therefore, the portable electronic device 1 is able to be clamped by and to intimately abut against the portable stand of this invention so as to reduce the occupied space for storage.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A portable stand for a portable electronic device, said portable stand comprising:
a handle rod;
a clamp including a clamp wall that has two opposite clamping portions for detachably clamping the portable electronic device and that has a base portion interconnecting said clamping portions; and
a connecting mechanism interconnecting pivotally said handle rod and said clamp such that said handle rod is foldable and rotatable to various angles relative to said clamp, said connecting mechanism including a socket member disposed on one of said handle rod and said clamp, and an engaging member disposed on the other one of said handle rod and said clamp, said socket member having a socket wall that has an open end edge and at least one slit extending from said open end edge in a direction away from said open end edge, and that defines a receiving space, which opens at said open end edge, said engaging member having a ball part that is rotatably mounted in said receiving space and a stem that is connected to said ball part and that is extendable into said slit when said handle rod is folded over said clamp.

2. The portable stand as claimed in claim 1, wherein said socket member is disposed on said handle rod, and has two spaced-apart said slits extending from said open end edge along a longitudinal direction of said handle rod.

3. The portable stand as claimed in claim 2, wherein each of said slits has a wide segment proximate to said open end edge, and a narrow segment distal from said open end edge, said stem of said engaging member having a stem diameter that is greater than a width of said narrow segment, and that is smaller than or equal to a width of said wide segment.

4. The portable stand as claimed in claim 3, wherein said base portion of said clamp wall has a back side facing said handle rod, said stem of said engaging member integrally projecting from said back side, and interconnecting said ball part and said back side, said socket member being integrally formed in one end of said handle rod.

5. The portable stand as claimed in claim 4, wherein said clamp further includes two cushion pads respectively disposed on said clamping portions.
